(19) United States
(12) Patent Application Publication
(10) Pub. No.: US 2009/0150580 A1
(43) Pub. Date: Jun. 11, 2009

(54) METHOD AND SYSTEM FOR COMPUTER MANAGEMENT

(75) Inventor: Guang-Chun Wen, Surrey (CA)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ATEN INTERNATIONAL CO., LTD., Taipei (TW)

(21) Appl. No.: 11/951,465

(22) Filed: Dec. 6, 2007

(51) Int. Cl. G06F 13/38

(52) U.S. Cl. 710/72

(57) ABSTRACT

A method and a system for computer management are provided. An embodiment of a computer management system controls a plurality of computers. A Keyboard-Video-Mouse (KVM) switch controls at least one computer by a control signal and receives video data output therefrom. A console is coupled to the KVM switch through a first network, comprising a user interface to provide the control signal and to display the video data. The console is capable of converting the video data into a video file, and the converted video file is then stored in a storage medium. The first network may be Internet, Ethernet, Intranet, Local Area Network (LAN), Wide Area Network (WAN) or wireless network or combinations thereof.

### BACKGROUND OF THE INVENTION

1. Field of the Invention

The invention relates to Keyboard-Video-Mouse (KVM) systems, and in particular, to mechanisms for session capture in KVM systems over Internet protocol (IP).

2. Description of the Related Art

Conventionally, a Keyboard-Video-Mouse (KVM) switch is used to control a plurality of computers via only one set of keyboard, video and mouse. A console is an integrated interface of the keyboard, video and mouse, coupled to the KVM switch for control of the computers. The console can be directly coupled to the KVM switch through a local end, or remotely connected to the KVM switch over Internet protocol (IP) infrastructures.

As known, session capture technology implemented for KVM switches to record and replay KVM activity exists. As described in US application US2007/0180160 published in Aug. 2, 2007, Schweig disclosed “KEYBOARD, VIDEO AND MOUSE SESSION CAPTURE” in which an additional hardware, CC-F appliance is attached to the KVM switch for storage and replay of captured sessions. In this case, a KVM switch supporting the CC-F appliance is an essential component for session capture. If the KVM switch does not support the CC-F appliance, then there is a need to record the session locally on the console end. However Schweig, does not teach how to record the session locally on the console end. It is therefore desirable to propose a more flexible architecture.

### BRIEF SUMMARY OF THE INVENTION

An exemplary embodiment of a computer management system is provided for control of a plurality of computers. A Keyboard-Video-Mouse (KVM) switch controls at least one computer by a control signal and receives video data output therefrom. A console is coupled to the KVM switch through a first network, comprising a user interface to provide the control signal and to display the video data. The console is capable of converting the video data into a video file, and the converted video file is then stored in a storage medium. The first network may be Internet, Ethernet, Intranet, Local Area Network (LAN), Wide Area Network (WAN), TCP/IP, ATM, wireless network or combinations thereof.

The video data comprises a consecutive of Joint Photographic Experts Group (JPEG) pictures each associated with a time stamp or other video data format (such as MEPG 1, 2, 4, or H.264). The format of the video file may conform to Moving Picture Experts Group (MPEG) standard. The console may read the video file from the storage medium and replay the video file on demand. The storage medium may be coupled to the console through LAN, however it is not limited to LAN, other networks such as WAN or wireless networks may or combination thereof also be used.

Another embodiment provides the console as described above, and a computer management method adaptable to the described above system. The console comprises a storage medium and a user interface providing a control signal and displaying video data. The console sends a control signal to the KVM switch to control a computer and receives video data output therefrom, and converts the video data into a video file and stores it in the storage medium.

The computer management method controls a plurality of computers. First, a control signal is provided via the KVM switch to a computer, such that video data output therefrom is displayed. The console then converts the video data to a video file and stores it in the storage medium.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an embodiment of a computer management system according to the invention; and

FIG. 2 is a flowchart of the computer management method implemented on the computer management system according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

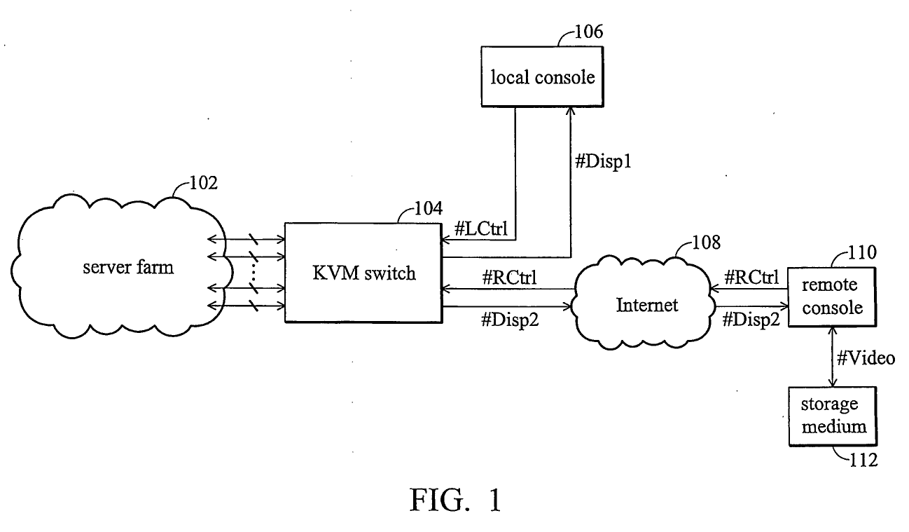

An embodiment of a computer management system according to the invention is shown in FIG. 1. A server farm 102 is a logical place where a plurality of computers resides. A KVM switch 104 is connected to the plurality of computers by individual cables to transmit keyboard, video and mouse signals. A local console 106 may be connected to the KVM switch 104 to directly control one of the computers. Through the KVM switch 104, local control signals #Lctr1 are sent from the local console 106 to the computer, and in response, video data #Disp1 is received and displayed on the local console 106. The KVM switch 104 may be KVM over IP (KVM). The local console 106 may include keyboard, mouse and monitor.

In the embodiment, computer management can also be performed remotely. A remote console 110 is connected to the KVM switch 104 through a first network, such as Internet 108, sending a remote control signal #Rctr1 and receiving video data #Disp2 using IP protocol. The remote console 110 is an integrated interface comprising keyboard, video and mouse, and is capable of converting/transforming/encoding/deconding/compressing/decompressing the video data #Disp2 into a video file #Video. As shown in FIG. 1, the remote console 110 is attached to a storage medium 112, whereby the video file #Video can be output for storage.

The format of the video data output from the KVM switch 104, may not be a motion picture stream, but consecutive static pictures each associated with a time stamp or other video data format (such as MEPG 1, 2, 4, or H.264). For example, the KVM switch 104 may output 15 to 30 Joint Photographic Experts Group (JPEG) pictures per second to represent what is displayed on the computer. The remote console 110 continuously receives the pictures to display, allowing interactive operations to be proceeded. The remote console 110 may include personal computer, notebook computer, laptop computer, desktop computer, personal digital assistant (PDA), cellular phone, or any portable electronic device.

When recording of the video data is required, the console converts the video data into a video file #Video, and stores the video file #Video into the storage medium 112. The format of the video file is compatible to common media players, such as Moving Picture Experts Group (MPEG) standards including MPEG2 and MPEG4. Other video compression technologies may also be adaptable to encode the video data into a video file, such as H.264 or DivX.

When replaying of the video file is required, the remote console 110 may be triggered by the user interface of the keyboard and mouse to replay the video file. The video file #Video is thereby read from the storage medium 112 and displayed on the remote console 110. Specifically, the storage medium 112 may be a local device embedded in the remote console 110, or a network disk coupled to the remote console 110 through a second network, such as Internet, Ethernet, Intranet, Local Area Network (LAN), Wide Area Network (WAN), wireless network or combinations thereof. Likewise, the IP based connection between the KVM switch 104 and remote console 110 may not be limited to the Internet, but can be combinations of the Internet, Ethernet, Intranet, LAN, WAN or wireless network. In one embodiment, the KVM switch 104 may be replaced by iKVM card disposed in each computer in the server farm 102. The computer having iKVM card may further includes IPMI card.

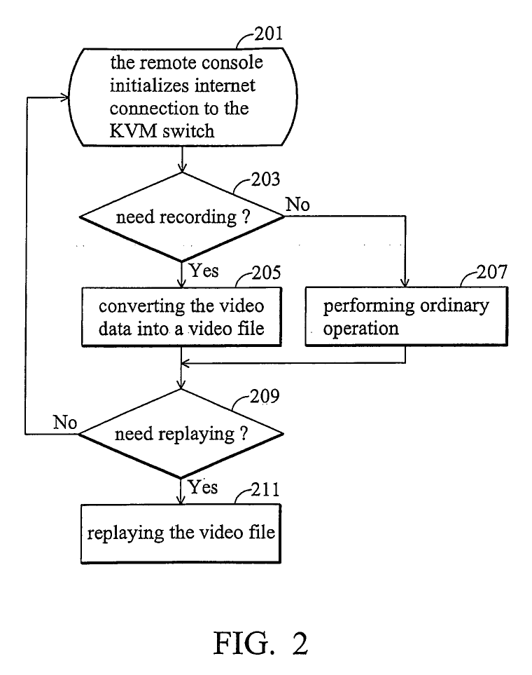

A flowchart of the computer management method implemented on the computer management system according to the invention is shown in FIG. 2. In step 201, the remote console 110 initializes Internet connection to the KVM switch 104, controlling one of the computers in the server farm 102. In step 203, it is determined whether to record the session. In step 205, if recording is required, the storage medium 112 is used to store a video file #Video generated by the remote console 110. If no recording is required, in step 207, the remote console 110 performs ordinary operation without storage medium 112. In step 209, it is determined whether to replay the recorded video file #Video. In step 211, if replaying is required, the video file #Video is read from the storage medium 112 and displayed on the remote console 110. Otherwise, the process returns to step 201.

Therefore, an interface is implemented on the remote console 110 to control starting or stopping of recording and replaying. The interface can be a hardware panel or a software program. The console can be a computer bundled with software capable of establishing an IP based connection with the KVM switch 104 through the Internet 108, whereby all the keyboard, mouse and video signals are transmitted in packet form. With the proposed architecture of the invention, a KVM switch 104 does not need to be modified with an additional CC-F appliance to accomplish a session capture task, thus increasing flexibility and compatibility while reducing costs.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A computer management system for control of a plurality of computers, comprising:
a Keyboard-Video-Mouse (KVM) switch, controlling at least one computer by a control signal and receiving video data output therefrom;
a console, coupled to the KVM switch through a first network, comprising a user interface to provide the control signal and to display the video data, wherein the console converts the video data into a video file; and
a storage medium, coupled to the console, storing the video file.

2. The computer management system of claim 1, wherein the video data comprises consecutive Joint Photographic Experts Group (JPEG) pictures each associated with a time stamp.

3. The computer management system of claim 1, wherein the format of the video file conforms to Moving Picture Experts Group (MPEG) standard.

4. The computer management system of claim 1, wherein the console further reads the video file from the storage medium and replays the video file on demand.

5. The computer management system of claim 1, wherein the storage medium is coupled to the console through a second network.

6. The computer management system of claim 5, wherein the second network includes Internet, Ethernet, Intranet, Local Area Network (LAN), Wide Area Network (WAN) or wireless network.

7. The computer management system of claim 1, wherein the first network includes Internet, Ethernet, Intranet, LAN, WAN or wireless network.

8. A console coupled to the KVM switch through a first network for control of a plurality of computers, comprising:
a storage medium; and
a user interface providing a control signal and displaying video data; wherein:
the console sends a control signal to the KVM switch to control a computer and receives video data output therefrom; and
the console converts the video data into a video file and stores it in the storage medium.

9. The console of claim 8, wherein the video data comprises consecutive JPEG pictures each associated with a time stamp.

10. The console of claim 8, wherein the format of the video file conforms to MPEG standard.

11. The console of claim 8, wherein the console further reads the video file from the storage medium and replays the video file on demand.

12. The console of claim 8, wherein the storage medium is coupled to the console through a second network.

13. The console of claim 12, wherein the second network includes Internet, Ethernet, Intranet, Local Area Network (LAN), Wide Area Network (WAN) or wireless network.

14. The console of claim 8, wherein the first network includes Internet, Ethernet, Intranet, Local Area Network (LAN), Wide Area Network (WAN) or wireless network.

15. A computer management method adaptable in a system comprising a KVM switch, a console and a storage medium, for control of a plurality of computers, comprising:
the console providing a control signal via the KVM switch to a computer and displaying video data output therefrom; and
the console converting the video data to a video file and storing it in the storage medium.

16. The computer management method of claim 15, wherein the video data comprises consecutive JPEG pictures each associated with a time stamp.

17. The computer management method of claim 15, wherein the format of the video file conforms to MPEG standard.

18. The computer management method of claim 15, wherein the console is connected to the computer through a first network, and the storage medium is coupled to the console through a second network.

19. The computer management method of claim 18, wherein:
the first network includes Internet, Ethernet, Intranet, LAN, WAN or wireless network; and
the second network includes Internet, Ethernet, Intranet, LAN, WAN or wireless network.

20. The computer management method of claim 15, further comprising, the console reading the video file from the storage medium and replaying the video file on demand.
